(19) United States
(12) Patent Application Publication
(10) Pub. No.: US 2007/0016472 A1
(43) Pub. Date: Jan. 18, 2007

(54) System and method of offering an incentive to prospective online purchasers of goods

(76) Inventor: Andrea S. Reznik, Saint Louis Park, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/181,553

(22) Filed: Jul. 14, 2005

(51) Int. Cl. G06Q 30/00

(52) U.S. Cl. 705/14

(57) ABSTRACT

A method of offering an incentive to a prospective purchaser of goods offered for sale through a client-server online system is disclosed. The method includes operating an affiliate host site on the client-server online system, and providing vendor information for a plurality of vendors to the prospective purchaser accessing the affiliate host site. The method additionally includes randomly generating a rebate incentive specific to a vendor selected by the prospective purchaser. The method further includes communicating the rebate incentive to the prospective purchaser.

### BACKGROUND

The present invention relates generally to electronic commerce, and more particularly to a method and system of offering an incentive to prospective online purchasers of goods.

Electronic commerce (e-commerce) is becoming a large and important segment of the economy. Recently, e-commerce has developed to an extent that virtually any good or service is available online, and generally from multiple sources.

Ever increasing numbers of users are connecting to distributed networks such as the Internet, with similarly expanding numbers of businesses following onto the networks to sell goods and services to these “online” users. However, as more and more businesses offer their goods for sale on the Internet, it is becoming more and more difficult for online users to locate a specific desired business or product when shopping on the Internet. As a result, a primary challenge for a prospective purchaser shopping on the Internet is to discriminate between the multiple online business vendors offering products or services for sale.

One known solution for efficiently directing prospective purchasers to a desired vendor or product for sale on the Internet is for a host to provide a virtual catalog of product and vendor information collected from a variety of vendors. The host is typically an entity on the network that provides a conduit between prospective purchasers and vendors. In this regard, the host does not purchase items from the vendors, and the host does not profit directly from sales by the vendors to the prospective purchasers. To this end, the host is referred to as “an affiliate” with the vendors. In particular, an affiliate host displays product information provided by the vendors, thus exposing the vendors to the prospective purchasers, in exchange for a commission paid by the vendors to the affiliate host. In this regard, the affiliate host does not participate in the operation of the vendors' business, or control administration of the vendors' inventory.

Affiliate hosts are popular with both online shoppers and vendors. Online shoppers desire to use affiliate hosts to research and order products because, as described above, the prospective purchasers can access a wide range of information related to multiple vendors. The subsequent high volume of online shoppers accessing the affiliate host website, therefore, also makes the affiliate host attractive to vendors.

The number of affiliate hosts present on the Internet has been expanding. While the vendors may attract new customers and encourage sales by providing special discounts and promotions, no analogous method exists for the affiliate host to increase website traffic. In particular, any discount that an affiliate host may offer to prospective purchasers is typically small and known ahead of time by the prospective purchasers. Thus, a prospective purchaser has little incentive to preferentially visit one affiliate host as compared to any other affiliate host. Therefore, a current need exists for affiliate hosts to distinguish themselves in the online market, and to attract more online shoppers.

### SUMMARY

Aspects of the present invention provide a useful, concrete, and tangible result of giving an incentive to online shoppers to visit at an affiliate host site, thereby beneficially exposing vendors of goods to more prospective purchasers of the goods. The incentive takes the form of a possible deep discount in product price available to the prospective purchaser through a randomly generated rebate. The practical utility of aspects of this business method invention include increased commerce for online vendors, and a corresponding increase in revenue in the form of commissions for affiliate hosts.

One aspect of the present invention provides a method of offering an incentive to a prospective purchaser of goods offered for sale through a client-server online system. The method includes operating an affiliate host site on the client-server online system, and providing vendor information for a plurality of vendors to the prospective purchaser accessing the affiliate host site. The method additionally includes randomly generating a rebate incentive specific to a vendor selected by the prospective purchaser. The method further includes communicating the rebate incentive to the prospective purchaser.

Another aspect of the present invention provides a method of affiliate marketing. The method includes promoting at least one vendor of goods on an affiliate website. The method additionally includes connecting a prospective purchaser of goods with the vendor(s) through the affiliate website. The method further includes offering a randomly generated incentive to the prospective purchaser to purchase goods from the vendor(s).

Yet another aspect of the present invention provides an affiliate marketing system. The affiliate marketing system includes a server, a client program electronically connected to the server, and a roulette program. The server includes an affiliate host offering product information for a plurality of vendors, and the client program is responsive to web browser commands directed through an electronic device operated by a prospective purchaser. The roulette program is controlled by the affiliate host. In this regard, when the prospective purchaser connects with a selected vendor of the plurality of vendors, the roulette program randomly generates a rebate incentive specific to the selected vendor, and the affiliate host communicates the rebate incentive to the prospective purchaser.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 illustrates an affiliate marketing system according to one embodiment of the present invention;

FIG. 2 illustrates a method of offering an incentive to a prospective purchaser of goods offered for sale through a client-server online system according to one embodiment of the present invention;

FIG. 3 illustrates a roulette algorithm for generating a random rebate incentive according to one embodiment of the present invention;

FIG. 4 illustrates a vendor database according to one embodiment of the present invention; and

FIG. 5 illustrates an algorithm for generating a random rebate incentive according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “first,” “next,” “top,” “bottom,” “front,” “back,” “leading,” “trailing,” etc., is used with reference to the orientation of the Figure(s) being described. Components of embodiments of the present invention can be positioned in a number of different orientations. Directional terminology is used for purposes of illustration and is in no way limiting. It is to be understood that other embodiments may be utilized, and structural or logical changes to algorithms may be made without departing from the scope of the present invention. The following detailed description, therefore, is not to be taken in a limiting sense, and the scope of the present invention is defined by the appended claims.

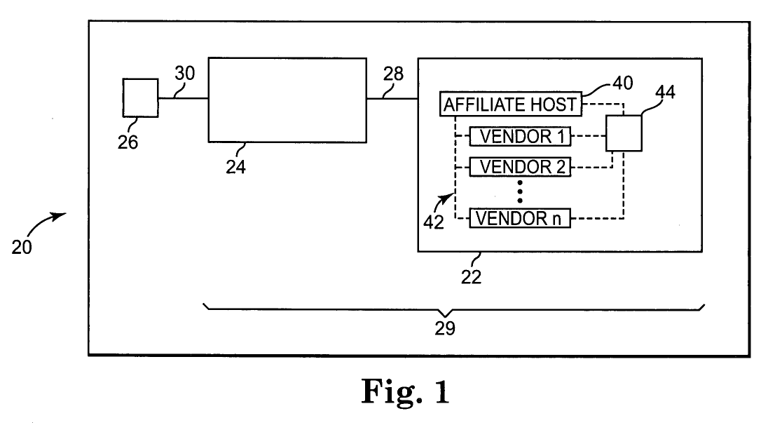

FIG. 1 illustrates an affiliate marketing system 20 according to one embodiment of the present invention. The affiliate marketing system 20 includes a server 22, a client program 24, and an electronic device 26 having access to the client program 24. In general, the server 22 and the client program 24 communicate via a connection 28 and form a client-server system 29. A user of the electronic device 26 accesses the client-server system 29 via an access connection 30. In one

embodiment, the connection 30 is a web-based connection and the user accesses the client-server system 29 remotely by a suitable Internet compatible device 26, described below, such that system 20 is a distributed communication system.

The server 22 resides on a site of the distributed communication system, and in one embodiment is a program that responsively interacts with the client program 24. In one embodiment, the server 22 includes an affiliate host 40 that provides user-accessible information for a plurality of vendors 42, and optionally includes an affiliate marketing tool 44 employed by the affiliate host 40 to monitor electronic interactions between users and the vendors 42.

The client program 24 in one embodiment is a program that resides at a site on the distributed communication system and is configured to query a separate program at a separate site (for example, the server 22) on the distributed communication system. In this regard, in one embodiment the client program 24 is a requesting program configured to “talk” to the server 22.

The electronic device 26 can be any device configured to access the client program 24. For example, electronic device 26 can include, but is not limited to, a computer, a personal data assistant (PDA), for example PDAs sold under the trademark BLACKBERRY, a cellular phone having Internet access, or any other device having access to the World Wide Web (i.e., a hypermedia interface for viewing and exchanging information represented as WWW). In this regard, connection 30 is, in general, an Internet web connection operable through a browser. With this in mind, connection 30 can include hardwired connections, or alternately wireless connections, between the electronic device 26 and the client-server system 29.

In one embodiment, the affiliate host 40 is an “online” business entity conducting e-commerce on the distributed communication system through the World Wide Web. That is to say, users of the World Wide Web can access the affiliate host 40 as an Internet site. In this manner, a user of the electronic device 26 can access the affiliate host 40, and thus access the vendors 42 and information related to vendors 42 as provided by the affiliate host 40. To this end, the affiliate host 40 website displays a wide range of vendor information including specific product information for a variety of products offered by the vendors 42. Transactions between the user and the vendors 42 on the affiliate host 40 website can be tracked (i.e., monitored and recorded) by the affiliate host 40 employing, in one embodiment, the online affiliate marketing tool 44, as more fully described below.

The plurality of vendors 42 includes, in one embodiment, a plurality of Internet accessible vendor sites, where each vendor site provides vendor-specific product information. In another embodiment, the plurality of vendors 42 includes a plurality of catalogs of product information that is accessible via the affiliate host 40 site. In any regard, a visitor to the affiliate host 40 site has access to the vendors 42 and can purchase goods from the vendors 42 via the affiliate host 40.

In general, the affiliate host 40 has established business relationships with the vendors 42. In this regard, the term “affiliate” references a relationship formed between the affiliate host 40 and the vendors 42, where the affiliate host 40 provides online vendor/product information specific to the vendors 42 in exchange for a commission paid to the affiliate host 40 by each one of the vendors 42. That is to say, an established rate of commission (ERC) has been agreed upon between each one of the vendors 42 and the affiliate host 40 for product sales transacted through the affiliate host 40 site.

A user of the electronic device 26 (for example, a prospective purchaser and hereafter referred to as a PP) desires access to the affiliate host 40 website because the business relationship between the affiliate host 40 and the vendors 42 provides one-stop shopping information that is useful to the PP. In this regard, the vendors 42 desire to associate with the affiliate host 40 to gain exposure to online traffic at the affiliate host 40 website, and the PP desires access to the affiliate host 40 website to gain access to product-specific and vendor-specific information. That is to say, the affiliate host 40 provides a business model that offers symbiotic and mutually beneficial interactions between PPs and the vendors 42.

Examples of mutually beneficial interactions between PPs and the vendors 42 include a “matrix” presentation on the affiliate host 40 site that provides a cross-reference to categories for each target group of PPs, and a method where an intersection of a cross-referenced category and target group directs PPs to a vendor specialty store the PP might find of interest. In particular, a PP accessing the affiliate host 40 site finds, in one embodiment, a general listing of categories cross-referenced to a variety of target groups, for example including, but not limited to, “women,” “teen girls,” “girls 0-12,” “men,” “teen boy,” and “boys 0-12.” In another embodiment, PPs are directed to a specialty store based upon an intersection of the category/target group as determined by the affiliate host 40 site. In this manner, men interested in the category of golf, for example, are directed to golf specialty stores. In this regard, vendor specialty stores are charged a fee for the increased level of PP traffic generated by the cross-referenced matrices described above.

Rebates made available to online shoppers are known. However, the PP is usually well aware of the existing (and highly similar) rebate offers available on the various host websites. Thus, the mere existence of a rebate offer available through a host website provides little incentive to the PP to visit the host website. In contrast, a new and advantageous method of offering an incentive to PPs accessing affiliate marketing system 20 provides an incentive that has the potential to deeply discount the product price through a randomly generated rebate, and is therefore highly enticing to PPs. That is to say, the PP could possibly save a significant amount of money by purchasing products from the vendors 42 on the affiliate host 40 site, and the PP also participates in the “thrill” of receiving a lottery-like offer of a randomly generated rebate, as described below.

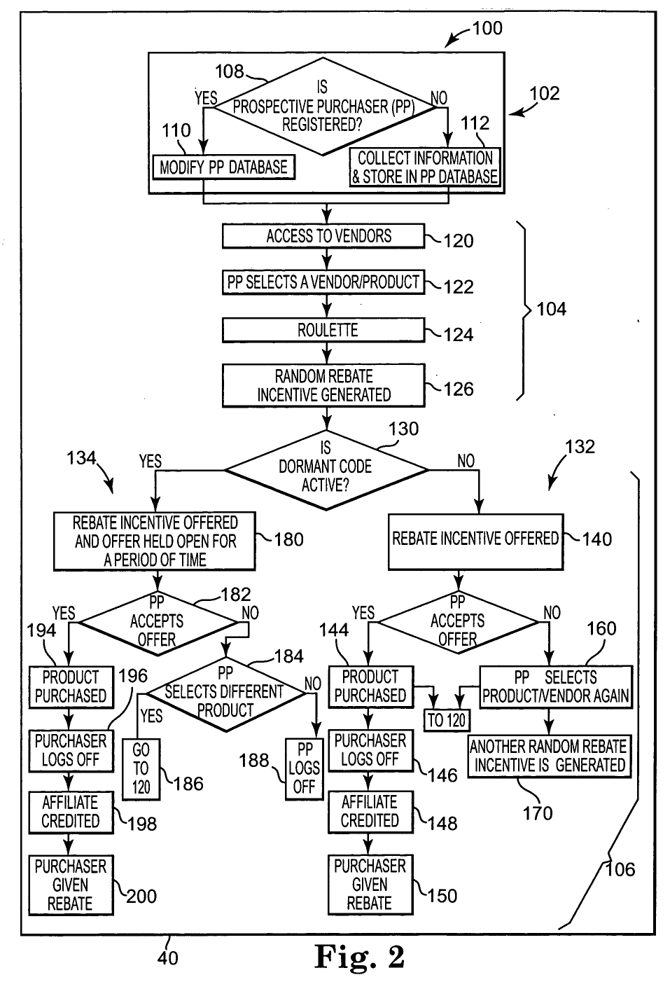

FIG. 2 illustrates a method 100 of offering an incentive to a prospective purchaser (PP) of goods offered for sale through a client-server online system according to one embodiment of the present invention. The method 100 provides registration 102 of a prospective purchaser, a random rebate generation 104, and a rebate offer 106.

Registration 102 provides a step 108 to recognize registered PPs, or alternately, registers PPs who are visiting the affiliate host 40 for the first time. During registration 102, if the PP is already registered with the affiliate host 40, step 110 modifies a prospective purchaser database (PP database). Alternately, if a prospective purchaser visiting the affiliate host 40 for the first time is not yet registered, step 112 provides a sub-routine to collect information and store the information in the PP database. With this in mind, only registered users are offered a randomly generated rebate incentive, thus registration step 102 provides a mechanism by which PPs visiting the affiliate host 40 website gain access to vendors 42 and their corresponding vendor information and qualify for rebate incentives.

The PP database includes information entered by the PP when visiting the affiliate host 40 website. The PP database includes information including, but not limited to, a unique number identifier, a user name, a password, a secret question and a corresponding secret answer, and an address to where the rebate incentive can be delivered, all of which are entered by the PP. The unique number identifier is, in one embodiment, a randomly generated number greater than 1 million. In another embodiment, the unique number identifier is a randomly generated number greater than 1 million minus 1.

Rebate generator 104 provides a PP (now registered) with access to vendors 42 (FIG.1) and their corresponding vendor information, and access to the opportunity for a rebate incentive. In particular, rebate generator 104 includes step 120 where the PP gains access to the vendors 42, a step 122 where the PP selects a vendor or a product from among the plurality of vendors 42, a roulette 124 sub-routine and a step 126 where a random rebate incentive is generated.

The rebate incentive can be presented to the PP in a variety of forms. For example, the rebate offer 106 includes a dormant code 130 that, when activated, can present and hold open the rebate offer for a selected period of time. In this regard, the dormant code 130 includes at least an inactive sub-routine 132 and an active sub-routine 134.

The dormant code 130 inactive sub-routine 132 includes step 140 where the rebate incentive is offered to the PP. In one embodiment, the PP can accept the offer by purchasing the product as selected in step 122. Step 144 represents a product purchase by the PP that manifests an acceptance by the PP of the rebate incentive offered in step 140. Thereafter, the PP can return to step 120 to view other vendors and/or other products. Alternately, the PP logs off from the affiliate host 40 in step 146. In any regard, after the PP purchases at least one product in step 144, the affiliate host 40 is credited with a commission (for example, as a percentage of the sale price) from the vendor that was selected by the PP in step 122 above. Thus, step 148 represents the affiliate host 40 being credited with a commission from the vendor. Ultimately, after purchase of goods through the affiliate host 40, the PP is given the rebate (generated in step 126) in either electronic or physical form, as best illustrated in step 150.

With reference to the inactive sub-routine 132, step 160 represents the case where the PP does not accept the rebate incentive offered. In this regard, and in particular when the dormant code 130 is inactive, the PP can re-enter the roulette 124 via step 122 in an attempt to generate a more desirable random rebate incentive. To this end, step 170 represents an iteration in the generation of random rebate offers when the dormant code 130 is inactive and the PP is enabled by the affiliate host 40 to generate multiple random rebate incentives and select from the most advantageous rebate incentive.

The dormant code 130 active sub-routine 134 is operable when dormant code 130 is active. In this regard, the random rebate incentive that was generated in step 126 is offered to the PP and the offer is held open for a selected period of time, as illustrated in step 180. In particular, step 180 prevents the PP from iteratively generating multiple random rebate incentives in an attempt to manipulate the affiliate host 40 into offering the highest possible incentive. Accordingly, step 180 offers a randomly generated rebate incentive to the PP that is specific to the vendor selected, or alternately, the rebate incentive offered is specific to the product(s) selected in step 122. In any regard, the PP is inhibited from bettering the rebate incentive offered in step 180 unless the PP selects a different vendor, or the PP selects a different product.

Step 182 illustrates a decision tree regarding acceptance of the offer by the PP. In step 184, the PP has declined the rebate incentive offered in step 180. Step 186 illustrates that the PP has chosen to make a different selection, and thus the PP is directed back to step 120 to access the vendors. Alternately, the PP affirmatively declines the rebate incentive offered in step 180 by logging off of the affiliate host 40 site as illustrated at step 188.

The PP can accept the offer by purchasing the product as illustrated in step 194. Step 194 is analogous to step 144 where purchasing the selected product manifests acceptance of the offer of the random rebate incentive by the PP. At the termination of the interaction, the PP logs off of the affiliate host 40 website in step 196, the affiliate is credited in step 198 by the selected vendor for the product purchased, and the PP is given the rebate, either electronically or by paper mail, in step 200.

With the above in mind, the randomly generated rebate incentive can include, but is not limited to, a rebate in the form of cash back on the purchase, a percentage rebate off of the purchase price, coupons good for future discounts with the same selected vendor, or other items of value earned via purchases (in whole or in part) such as airline tickets, electronic goods, or the like.

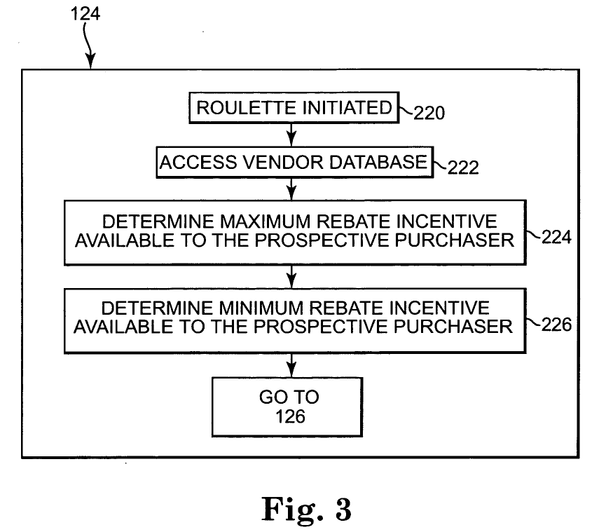

FIG. 3 illustrates an algorithm for roulette 124 according to one embodiment of the present invention. The roulette 124 algorithm provides a step 220 where the roulette 124 is initiated. In this regard, step 220 occurs after a (registered) PP selects a vendor, or after a PP selects a specific product, as described above. That is to say, once the PP has selected a specific good offered for sale, the roulette 124 is initiated in step 220 to generate a possible product discount that is possibly larger than any other discount available online to the PP.

Thereafter, the roulette 124 provides a step 222 that accesses a vendor database. Access and control of the vendor database at step 220 is restricted to the affiliate host 40. As more fully described below, the vendor database includes a broad range of information that permits affiliate host 40 (through the roulette 124) to randomly generate a rebate incentive that is of value to the PP and economically beneficial to the affiliate host 40.

To this end, the roulette 124 provides a step 224 where the algorithm determines a maximum rebate incentive available to the PP, and a step 226 where the algorithm determines a minimum rebate incentive available to the PP. In a preferred embodiment, the random rebate incentive is generated as a function of the maximum and the minimum rebate incentive available to the PP. Ultimately, the roulette 124 provides a route back to step 126 where the random rebate incentive is accordingly generated. Thus, by employing information available in the vendor database in step 222, the roulette 124 is configured to generate a random rebate incentive that is beneficial to both the PP and the affiliate host 40.

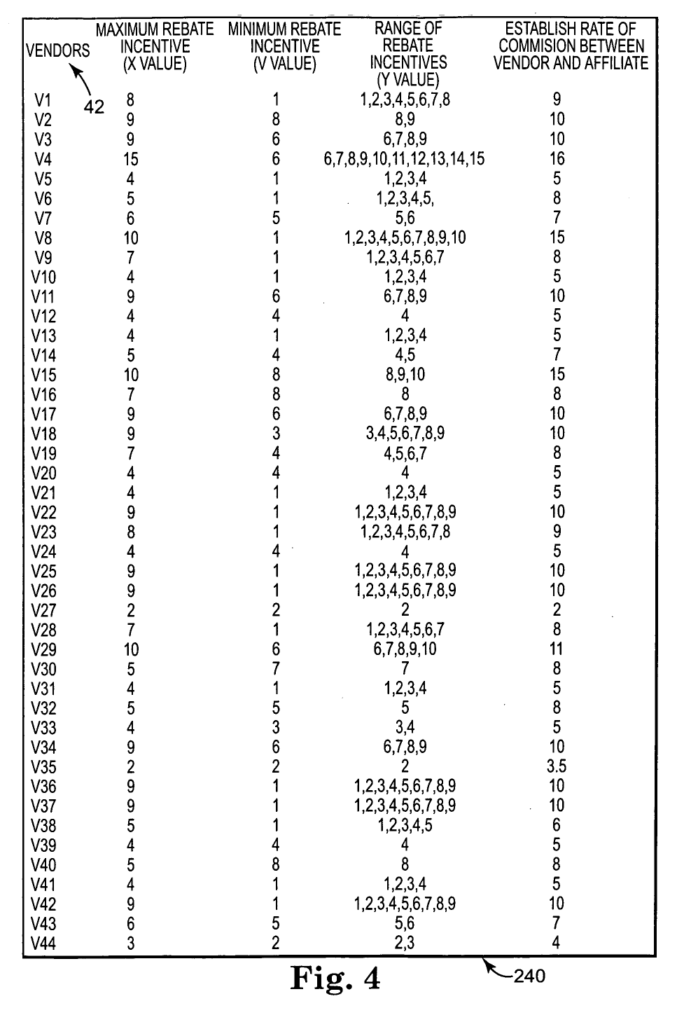

FIG. 4 illustrates a vendor database 240 according to one embodiment of the present invention. As noted above, the vendor database is controlled by the affiliate host 40 and is not available to the PP. The vendor database 240 includes a separate line item for each of the plurality of vendors 42 (V1-V44) having vendor information specific for each of the plurality of vendors 42. In particular, each vendor has associated with it a maximum rebate incentive termed an X value, and a minimum rebate incentive termed a V value. Based upon the X value and the V value, a range of rebate incentives known as a Y value is determined. In addition, the vendor database 240 includes an established rate of commission (ERC) between each of the vendors 42 and the affiliate host 40.

The Y value range of rebate incentives defines a range from which the randomly generated rebate incentive is selected. In this regard, the Y value range relates to the amount of the ERC that is retained by the affiliate host 40 as a variable percent of the commission. In general terms, the affiliate host 40 retains a portion of the Y value range that is not otherwise awarded to a purchaser. Using vendor VI as an example, the Y value range of rebate incentives varies from 1 to 8, and thus the range has a magnitude of 7 (i.e., 8-1). In this limited example, the affiliate host 40 will retain from 1% of the transaction (if the purchaser draws a maximum rebate of 8%) to 8% (if the purchaser draws a minimum rebate of 1%).

As a point of reference, the ERC is a commission percentage agreed upon between the affiliate host 40 and a specific vendor. In this regard, the maximum rebate incentive (X value) could be equal to the ERC, but for reasons related to good business practice, the X value is preferably less than the ERC.

In this regard, it is noted that the established rate of commission between each of the vendors 42 and the affiliate host 40 is preferably not employed as a variable in step 126 (FIG. 2) in generating the random rebate incentive. In particular, the X value and the V value are employed in step 126 in generating the random rebate incentive, and although the X value and the V value relate to the ERC, it is noted that this information is not available for viewing or use by the PP.

With the above in mind, in one embodiment the maximum rebate incentive (X value) is always less than the ERC. In one embodiment, the minimum rebate incentive (V value) is always greater than one, such that the range of rebate incentives (Y value) is always greater than one and always less than the ERC.

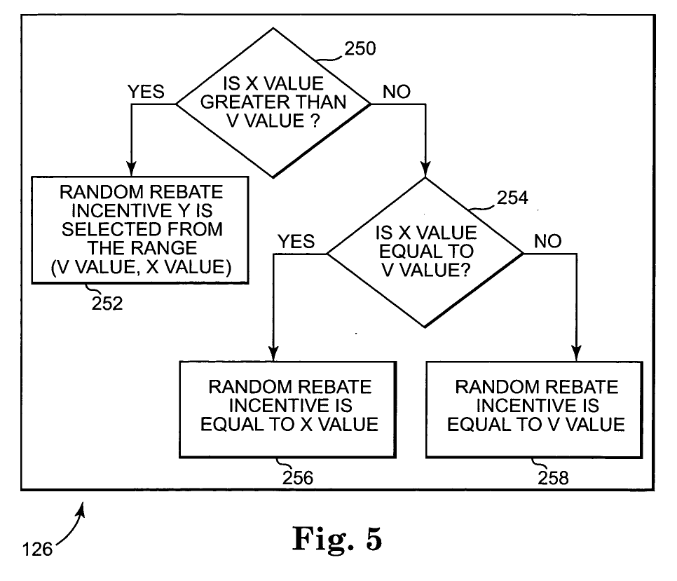

FIG. 5 illustrates an algorithm of step 126 for the generation of random rebate incentives according to one embodiment of the present invention. The algorithm provides a step 250 inquiring whether the X value is greater then the V value. If the X value is greater than the V value, the algorithm provides step 252 where the random rebate incentive is selected from the range of values between the V value as a minimum and the X value as a maximum rebate incentive, inclusive. Otherwise, the algorithm provides a step 254 that queries whether the X value is equal to the V value. If the X value is equal to the V value, the algorithm provides a step 256 where the random rebate incentive is set equal to the X value. If the X value is not equal to the V value (i.e., the V value must therefore be greater than the X value at this step in the algorithm), then the random rebate incentive is set equal to the V value in step 258.

A method of offering an incentive to a prospective online purchaser of goods has been described where the PP is offered a randomly generated rebate incentive that is possibly much larger than other rebate incentives available to the PP for similar vendors of similar goods. In particular, and with additional reference to FIGS. 1 and 2, a PP who is a user of the electronic device 26 browses the client-sever system 29, for example by a web browser, and arrives at a website operated by the affiliate host 40. The affiliate host 40 provides a wide range of information related to the vendors 42 and products offered by the vendors 42. The PP, having interest in the vendors 42 and their products, makes a selection (step 122) and is offered via rebate offer 106 a randomly generated rebate incentive. Information related to the availability of potentially large rebates can be expected to spread rapidly in the online environment, thus increasing traffic of PPs to the affiliate host 40 site.

With the above in mind, the PP may be visiting the affiliate host 40 for the first time, or alternately, the PP may be selectively visiting the affiliate host 40 with the knowledge that the randomly generated rebate incentive has the possibility of being relatively larger than any other such rebate incentive offered by other Internet sites for similar vendors and similar products. As described above, an inactive subroutine 132 permits the PP to iteratively generate multiple random rebate incentive offers and select from among the most desirable rebate incentives.

In a preferred embodiment, the dormant code 130 includes an active subroutine 134 that offers and holds open the offer of the rebate incentive for a period of time (step 180). In this manner, the PP acknowledges the possibility of receiving a beneficial rebate incentive and visits the affiliate host 40 with the desire to obtain a rebate incentive of a high value. The dormant code 130, when activated by the active subroutine 134, inhibits the PP from iteratively manipulating the affiliate host 40 into generating multiple randomly generated rebate incentives. Thus, the opportunity to receive a beneficial rebate incentive is balanced by the opportunity by the affiliate host 40 to maximize a retained portion of the ERC.

The roulette 124 balances the opportunity of the PP to receive a highly beneficial rebate incentive, with the opportunity for the affiliate host 40 to maximize a retained portion of the ERC, while also increasing PP traffic to the affiliate host 40 website. In the manner described above, prospective purchasers have an incentive to visit the affiliate host 40 website, and vendors have an incentive to engage in commerce with the affiliate host 40 in an attempt to be exposed to the increased e-commerce traffic at the affiliate host 40 website.

With additional reference to FIG. 1, the server 22 optionally includes the affiliate marketing tool 44 that is employed by the affiliate host 40 to monitor, track, and manage transactions between users (i.e., registered PPs) and the vendors 42. In one embodiment, the affiliate marketing tool 44 is an online pay-for-performance affiliate marketing management service available through the client-server system 29 as provided by one of a LINKSHARE or a COMMISSION JUNCTION Internet site.

In this regard, it can be advantageous for the affiliate host 40 to employ the affiliate marketing tool 44 to track the many transactions between the multiple PPs and the plurality of vendors. For example, in one embodiment the affiliate host 40 and each of the vendors 42 “sign up” with the affiliate marketing tool 44. For a fee, the affiliate marketing tool 44 accounts for each registered PP with each vendor on the affiliate host 40 site. The affiliate marketing tool 44 can be configured to deliver the randomly generated rebates to the PP and to disburse commissions earned by the affiliate host 40 from the vendors 42 for the online purchases.

With this in mind, in one embodiment the PP database of steps 110 and 112 (FIG. 2) can include an additional SID field. The SID field is an identification code that the affiliate marketing tool 44 employs to track purchases by each registered PP. In this manner, the affiliate marketing tool 44 can more accurately track PP purchases, and more efficiently credit the affiliate host 40 for the purchases.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of offering an incentive to a prospective purchaser of goods offered for sale through a client-server online system comprising:
operating an affiliate host site on the client-server online system;
providing vendor information for a plurality of vendors to the prospective purchaser accessing the affiliate host site;
randomly generating a rebate incentive specific to a vendor selected by the prospective purchaser; and
communicating the rebate incentive to the prospective purchaser.

2. The method of claim 1, wherein the vendor information resides on a server and is accessed by a web browser operated by the prospective purchaser.

3. The method of claim 1, wherein providing vendor information includes providing a catalog of product information for a plurality of products offered for sale by the plurality of vendors.

4. The method of claim 1, wherein providing vendor information includes registering the prospective purchaser with the affiliate host site.

5. The method of claim 4, wherein registering the prospective purchaser includes assigning a unique number identifier to each prospective purchaser.

6. The method of claim 4, wherein registering the prospective purchaser includes logging in a registered prospective purchaser to the affiliate host site.

7. The method of claim 1, wherein randomly generating a rebate incentive includes:
determining a minimum rebate incentive available to the prospective purchaser;
determining a maximum rebate incentive available to the prospective purchaser; and
generating a rebate incentive for communication to the prospective purchaser by randomly selecting a rebate value from the range defined by the minimum rebate incentive and the maximum rebate incentive.

8. The method of claim 7, wherein the rebate value is equal to the minimum rebate incentive.

9. The method of claim 7, wherein the rebate value is equal to the maximum rebate incentive.

10. The method of claim 7, further comprising:
determining an established rate of commission between each of the plurality of vendors and an affiliate host promoting the plurality of vendors.

11. The method of claim 10, wherein the maximum rebate incentive is less than the established rate of commission.

12. The method of claim 1, wherein communicating the rebate incentive to the prospective purchaser includes offering an item-specific rebate incentive to the prospective purchaser.

13. The method of claim 1, wherein communicating the rebate incentive to the prospective purchaser includes holding open an offer of the rebate incentive to the prospective purchaser for at least one day.

14. The method of claim 13, wherein holding open an offer includes renewing an offer of a vendor-specific rebate incentive to the prospective purchaser each time within a period of at least one week the prospective purchaser accesses the selected vendor through the affiliate host site.

15. The method of claim 14, wherein renewing an offer of the vendor-specific rebate incentive includes making dormant the vendor-specific rebate incentive to the prospective purchaser relative to the selected vendor.

16. The method of claim 1, further comprising:
employing an affiliate marketing tool to track transactions between a registered purchaser and at least one of the plurality of vendors accessed via the affiliate host site.

17. A method of affiliate marketing comprising:
promoting at least one vendor of goods on an affiliate host website;
connecting a prospective purchaser of goods with the at least one vendor through the affiliate host website; and
offering a randomly generated incentive to the prospective purchaser to purchase goods from the at least one vendor.

18. The method of claim 17, wherein offering a randomly generated incentive includes initiating a roulette sub-routine to generate a rebate incentive selected from a range of possible rebates.

19. The method of claim 18, wherein initiating a roulette sub-routine includes:
determining an established rate of commission between the at least one vendor and an affiliate host;
determining a minimum rebate incentive available from the affiliate host to the prospective purchaser; and
determining a maximum rebate incentive available from the affiliate host to the prospective purchaser;
wherein the maximum rebate incentive is less than the established rate of commission.

20. An affiliate marketing system comprising:
a server including an affiliate host offering product information for a plurality of vendors;
a client program electronically connected to the server, the client program responsive to web browser commands directed through an electronic device operated by a prospective purchaser; and
a roulette program controlled by the affiliate host;
wherein when the prospective purchaser connects with a selected vendor of the plurality of vendors, the roulette program randomly generates a rebate incentive specific to the selected vendor, and the affiliate host communicates the rebate incentive to the prospective purchaser.
